(19) United States
(12) Patent Application Publication
(10) Pub. No.: US 2017/0048133 A1
(43) Pub. Date: Feb. 16, 2017

(54) PHYSICAL LAYER CROSS-CONNECT SWITCH

(71) Applicant: xCelor LLC, Chicago, IL (US)

(72) Inventors: Robert James Walker, Chicago, IL (US); Sergey Sardaryan, Mississauga (CA)

(21) Appl. No.: 14/877,704

(22) Filed: Oct. 7, 2015

Related U.S. Application Data
(60) Provisional application No. 62/204,344, filed on Aug. 12, 2015.
(60) Provisional application No. 62/204,350, filed on Aug. 12, 2015.
(60) Provisional application No. 62/204,353, filed on Aug. 12, 2015.

(51) Int. Cl. H04L 12/751; H04L 29/08; H04L 12/26

(52) U.S. Cl. CPC H04L 45/02; H04L 43/06; H04L 43/0864; H04L 69/323

(57) ABSTRACT

Systems and methods for configuring, maintaining and monitoring a layer 1 switching network using physical layer cross-connect switches having a switch controller that configures, manages and monitors data path segments forming links in communication paths.

### CROSS-REFERENCE TO RELATED APPLICATIONS

This application claims the benefit of, and hereby incorporates by reference herein in their respective entireties, the following three U.S. Provisional Patent Applications: Ser. No. 62/204,344, filed Aug. 12, 2015, entitled “Systems and Methods for Monitoring and Managing Communication Paths;” Ser. No. 62/204,350, filed Aug. 12, 2015, entitled “Systems and Methods for Identifying Interconnections Among Physical-Layer Cross-Connect Switches;” and Ser. No. 62/204,353, filed Aug. 12, 2015, entitled “Physical-Layer Cross-Connect Switch.” Furthermore, this application is being filed contemporaneously with two other non-provisional U.S. Patent Applications, the entire contents of both of which are hereby incorporated herein by reference. The first such application is entitled “Systems and Methods for Monitoring and Managing Communication Paths,” filed Oct. 7, 2015, having Attorney Docket No. XLR-71064US02. The second such application is entitled “Systems and Methods for Identifying Interconnections Among Physical-Layer Cross-Connect Switches,” filed Oct. 7, 2015, having Attorney Docket No. XLR-71065US02.

### BACKGROUND

This disclosure relates to digital networking, specifically to the replication and switching of digital data signals over a network.

Data centers are, in general, facilities that house computers, storage systems, computer network components, telecommunications equipment and other associated equipment. A data center may house storage systems and servers for service providers and companies such as Google, or Facebook, and operate as distribution centers for telecommunications and data services in buildings, campuses, or communities. One or more data or telecommunications service providers provide feeds to the data center for distribution to customers, users, servers, routers, etc. in the area served by the data center.

A basic function in typical data centers is layer 1, or physical layer, routing. A physical route is typically a hard-wired physical connection between networked equipment on one end and networked equipment on another end in a manner that connects a service or a user to another service or user. In one example, a data center may provide feeds from one or more service providers and use a physical patch panel to connect the feeds to a number of servers, of customer equipment that further directs data to ultimate users on a layer 2 and 3 level.

Early patch panels were typically configured such that the service feeds connected to a back panel, and physical connections were manually created between the feeds and ports connected to the customer equipment. Larger facilities used multiple patch panels that connect users or providers on one end to users or providers on another end. Service feeds and connections to servers and higher layer network equipment are physical connections implemented using hardwire or optical cables.

Physical layer switches have evolved and are now available as a set of programmable links between ports on devices known as cross-connect or crossbar switches. Multiple cross-connect switches may be connected to one another to expand the number of options for forming paths between endpoints.

Physical switches now allow for entire paths across multiple cross-connect switches to be provisioned from a management station. Still, much of the wiring and cabling must be performed manually. While sensors and signal monitors allow for the detection of signal drops and other physical signal characteristics, the information is managed and monitored manually at the switch device. The configuration of communication paths across different switch units may be automated. However, the detection of signal drops or problems in the communication paths still requires manual, on-site vigilance. There is a need in the art for remote communication path provisioning along with signal monitoring and the ability to remotely perform remedial or warning actions when faults or error conditions are detected.

### BRIEF DESCRIPTION OF THE DRAWINGS

A more detailed understanding may be had from the following description, presented by way of example in conjunction with the accompanying drawings, which are first briefly described below.

FIG. 1 is a block diagram of an example of a system for managing communication paths across multiple cross-connect devices.

FIG. 2 is a block diagram of an example of a cross-connect switch used in the system in FIG. 1.

FIG. 3 is a table illustrating an example of a port mapping for the physical layer switch system illustrated in FIG. 1.

FIG. 4 is a flowchart illustrating operation of an example of a method for performing non-intrusive signal monitoring.

FIG. 5 is a flowchart illustrating operation of an example a method for monitoring a signal along a secure communication path formed by a network of physical layer switches.

FIG. 6A is a flowchart illustrating operation of an example of an intrusive method for measuring latency in a network of physical layer switches.

FIG. 6B is a flowchart illustrating operation of an example of a non-intrusive method for measuring latency in a network of physical layer switches.

FIG. 7A is a flowchart illustrating operation of an example of an intrusive method for interrogating a network of physical layer switches to identify used and unused paths in a network of physical layer switches.

FIG. 7B is a flowchart illustrating operation of another example of an intrusive method for interrogating a network of physical layer switches to identify used and unused paths in a network of physical layer switches.

FIG. 8 is a flowchart illustrating operation of an example of a non-intrusive method for interrogating a network of physical layer switches to identify paths in a network of physical layer switches.

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application.

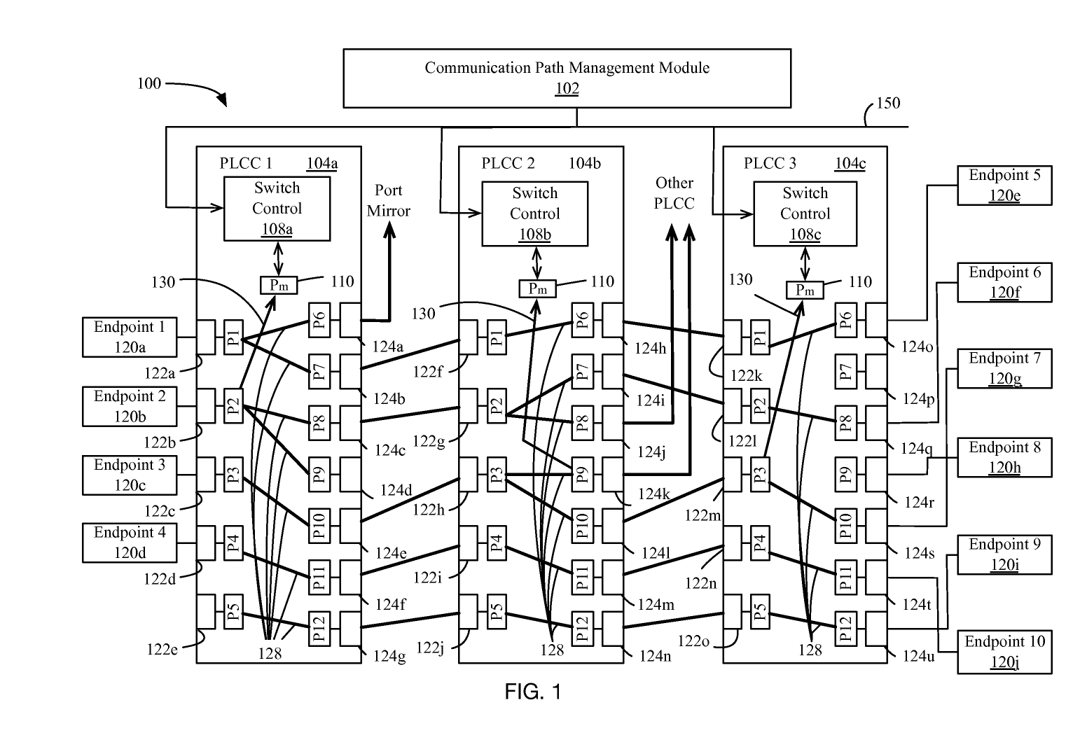

FIG. 1 is a block diagram of an example of a system 100 for managing communication paths across multiple cross-connect switches 104a-c. The system 100 includes a communication path management module 102, the plurality of physical layer cross-connect (PLCC) switches 104a-c, and a management bus 150. The plurality of PLCC switches 104a-c in the system 100 illustrated in FIG. 1 includes a first PLCC switch 104a, a second PLCC switch 104b, and a third PLCC switch 104c. The communication path management module 102 configures and manages communication paths that interconnect the first PLCC switch 104a, the second PLCC switch 104b, and the third PLCC switch 104c by communicating with the PLCC switches 104a-c over the management bus 150. The path management module may comprise a server computer, which may also provide a user interface to allow an operator to provide management data inputs, such as via a web user interface, etc.

The system 100 in FIG. 1 illustrates an example in which a first plurality of endpoints 120a-d are connected to a second plurality of endpoints 120e-120j by a plurality of end-to-end communication paths interconnecting the PLCC switches 104a-c. The connections between the endpoints 120a-j are formed by programming each PLCC switch 104a-c to form data path segments 128 between selected ports. The selection of the ports used to form the data path segments 128 depends on connections between the PLCC switches 104a-c such that one or more paths are formed between each of the first endpoints 120a-d and the second endpoints 120e-j.

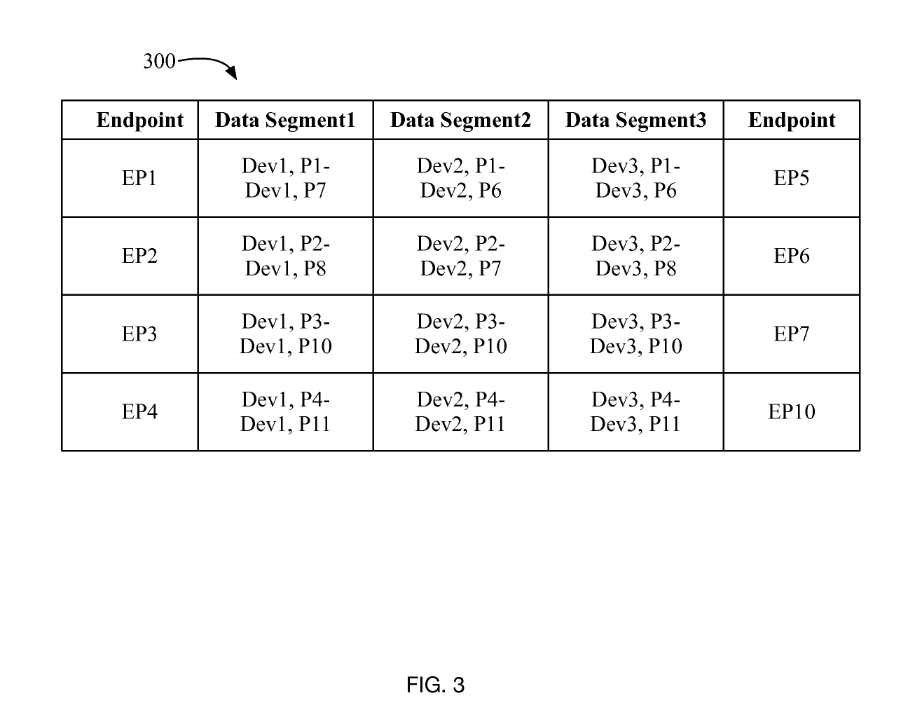

The communication path management module 102 includes a processor and a computer-readable storage medium (not shown) for storing software functions that perform path configuration functions, path monitoring functions and path troubleshooting functions as described in more detail below with reference to FIGS. 3-7. The communication path management module 102 performs the functions by sending commands to the PLCC switches 104a-c over the management bus 150. Some commands request a response from the PLCC switches 104a-c. Responses to such commands are received by the communication path management module 102 over the management bus 150 and processed according to the function being performed.

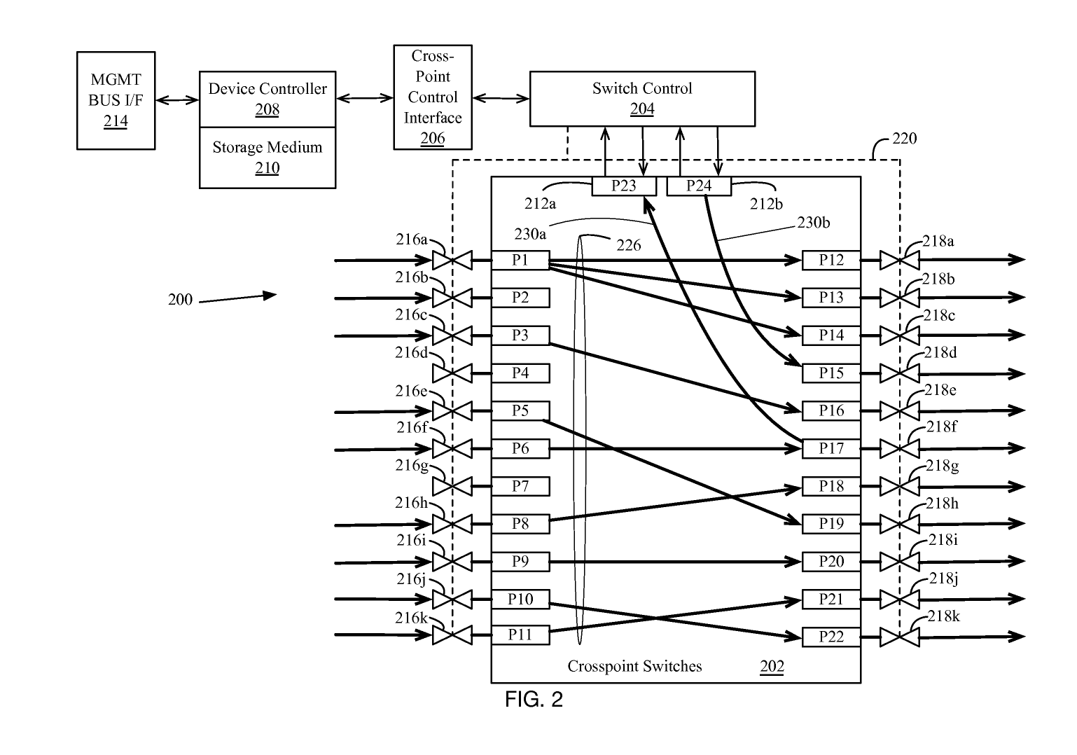

Each of the three PLCC switches 104a-c in FIG. 1 includes a switch controller 108a-c to execute configuration commands and monitoring commands as described in further detail below with reference to FIG. 2. The PLCC switches 104a-c also include a plurality of ports P1-P12 between which data path segments 128 may be formed in response to commands containing configuration settings. The plurality of ports P1-P12 may include ports that are configured to operate as input ports, ports configured to operate as output ports, or ports that may be configured to operate as either an input port or an output port based on a configuration setting (bidirectional ports). It is noted that in example embodiments, the data path segments 128 between two ports is bi-directional regardless of a port's designation as input or output port. As used herein, an input port is any port receiving data to the PLCC switch, and an output port is any port transmitting data from the PLCC switch.

Referring to FIG. 1, the plurality of ports P1-P12 in the PLCC switches 104a-c may be mapped in a mesh network in which input ports are connected to multiple output ports (one-to-many, or 1-M). Ports may be connected to other PLCC switches, such as the connection between port P7 on PLCC 1 104a and port P1 on PLCC 2 104b. In an example implementation, the system 100 in FIG. 1 may be a subset of a system having additional PLCC switches not shown in FIG. 1. Ports on the PLCC switches 104a-c may connect to other PLCC switches not shown as shown at ports P8 and P9 on PLCC 2 104b. Ports on the PLCC switches 104a-c may also be configured to mirror signals input to the ports as shown for example at port P6 of PLCC 1 104a. Mirrored ports may be connected to test equipment, for example, or to devices that may analyze or test the signals being mirrored. The ports may be configured 1-to-M allowing for port mirroring to be performed non-intrusively; that is, without affecting communication along the path being tested.

Commands sent by the communication path management module 102 that include configuration settings instruct the PLCC switches 104a-c to form the links, or data path segments, in each PLCC switch 104a-c. The data path segments connect to create end-to-end communication paths connecting the first plurality of endpoints 120a-d with the second plurality of endpoints 120e-j. In the system 100 in FIG. 1, the first plurality of endpoints 120a-d connects to the first PLCC switch 104a via a plurality of receiver devices 122a-122d, each of which is connected to a corresponding input port P1-P4 on the first PLCC switch 104a. Each of the plurality of PLCC switches 104a-c is programmed responsive to commands from the communication path management module 102 to form data path segments 128 between an input port P1-P5 and an output port P6-P12.

Each of the output ports P6-P12 on the first PLCC switch 104a is connected to a corresponding transmitter device 124a-g, which connects to receiver devices 122f-j connected to the second PLCC switch 104b. The receiver devices 122f-j are connected to corresponding input ports P1-P5 on the second PLCC switch 104b. The second PLCC switch 104b is programmed responsive to commands from the communication path management module 102 to form data path segments 128 connecting the input ports P1-P5 to output ports P6-P12 as shown in FIG. 1. Each of the output ports P6-P12 on the second PLCC switch 104b is connected to a corresponding transmitter device 124h-n, which connects to receiver devices 122k-o connected to the third PLCC switch 104c. The receiver devices 122k-o of the third PLCC switch 104c are connected to corresponding input ports P1-P5 on the third PLCC switch 104c. The third PLCC switch 104c is programmed responsive to commands from the communication path management module 102 to form data path segments 128 connecting the input ports P1-P5 to output ports P6-P12 as shown in FIG. 1. The output ports P6-P12 on the third PLCC switch 104c are selectively connected to the second plurality of endpoints 120e-j via transmitter devices 124o-u.

It is noted that the receiver devices 122a-o and the transmitter devices 124a-u connected to the ports on the PLCC switches may be implemented using transceivers to permit bi-directional data flow. A receiver may be a transceiver connected to an input port. A transmitter may be a transceiver connected to an output port.

The interconnections through the PLCC switches 104a-c connect generic endpoints to generic endpoints in the example shown in FIG. 1. In different example implementations, the entities connecting at the endpoints 120a-j may be any entity providing or consuming or distributing data services over data networks. In one example, the configuration of interconnections through the PLCC switches 104a-c may be used to implement a variety of use cases involving distribution of data services from one or more service providers to one or more service customers. For example, each of the first endpoints 120a-d may be a service provider such as AT&T, Comcast, and other telecommunications or Internet service providers, and each of the second endpoints 120e-j may be servers and routers that connect to customer entities, or subscribers of the services provided by the service providers. It is noted that these examples are described to provide context and clarity, and are not intended to be limiting. The interconnections through the PLCC switches 104a-c may be used to connect any combination of entities that may connect at the physical, or layer 1, level.

The PLCC switches 104a-c forming the paths between the endpoints also include monitoring capabilities that provide the communication path management module 102 with information regarding the status of the communication paths. The switch controller 108a-c in each PLCC switch 104a-c may scan the ports on each device and periodically send information to the communication path management module 102. The communication path management module 102 may send commands requesting specific information from each PLCC switch 104a-c.

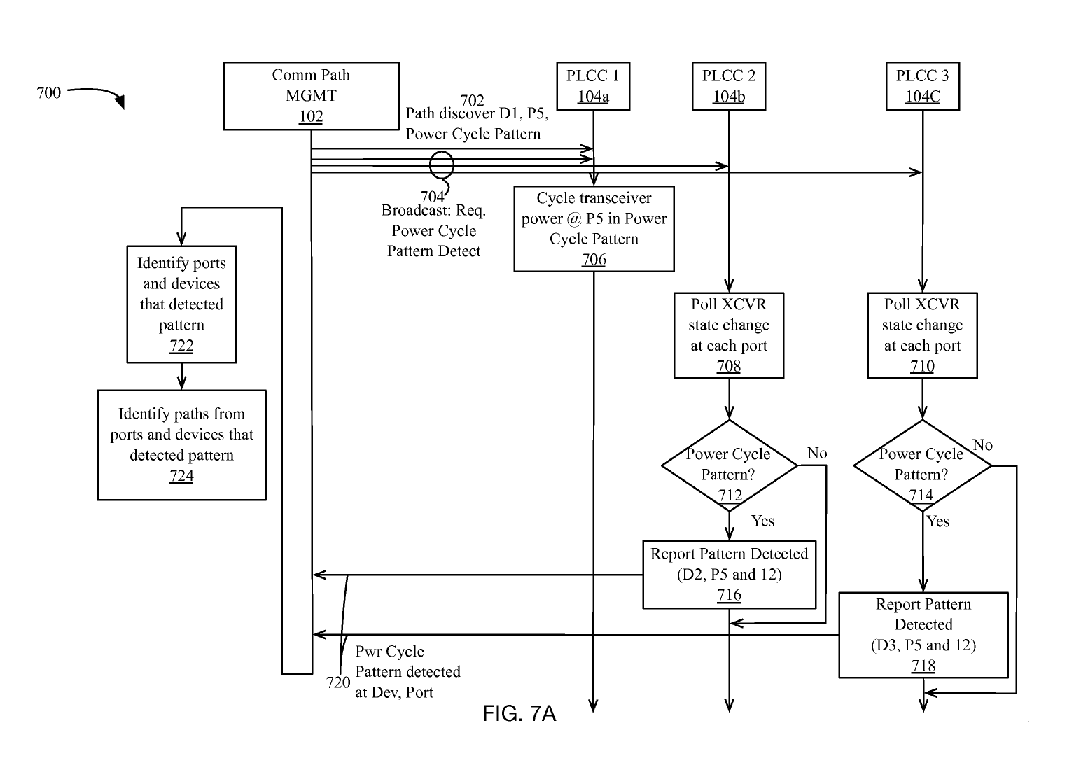

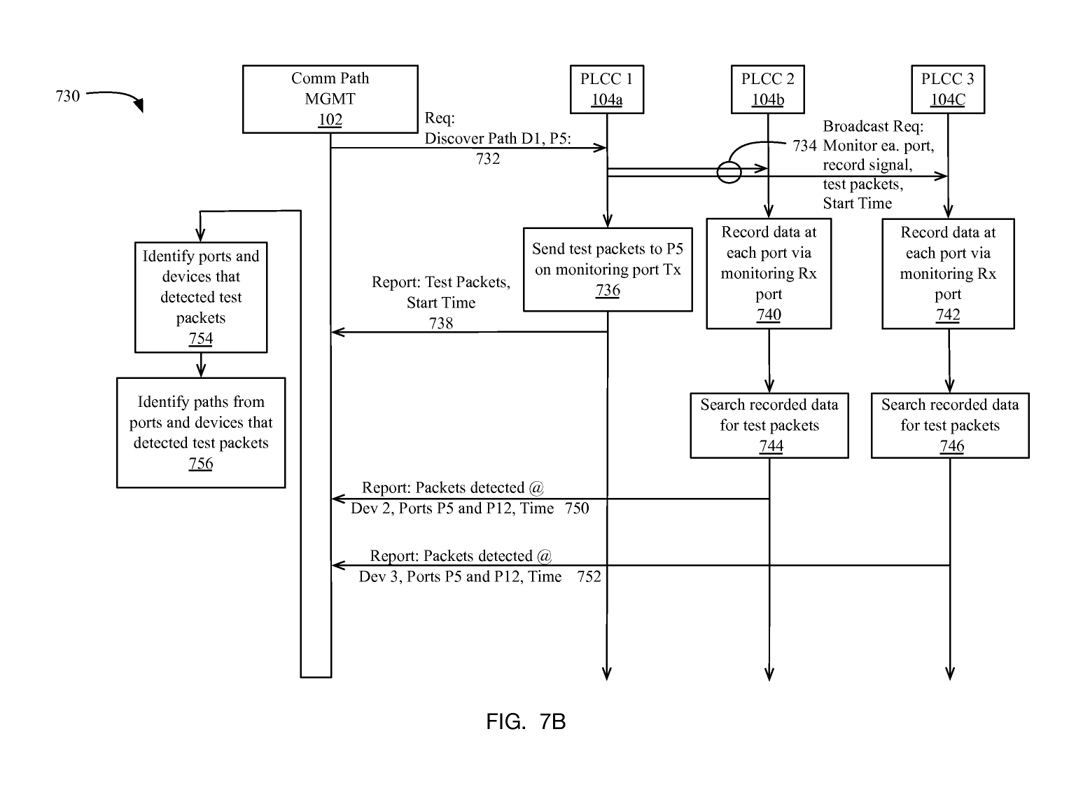

The switch controller 108a-c in each PLCC switch 104a-c connects to a monitor port Pm 110. The switch controller 108a-c may be configured to select one or more ports to monitor by selectively connecting the one or more ports to the monitor port 110 over a monitoring path 130. The example shown in FIG. 1 depicts port P1 on the first PLCC switch 104a connected to the monitor port 110 via the monitoring path 130. The switch controller 108a-c may connect to selected ports at selected times to receive and analyze replicated signals at the selected ports. The switch controller 108a-c may also connect to selected ports at selected times to transmit data to the selected port. Data may be transmitted to a selected port from the monitor port 110 in performing diagnostic functions, such as for example, a path discovery process as described below with reference to FIG. 7B.

It is noted that the example illustrated in FIG. 1, each PLCC switch 104a-c includes a single monitor port 110. In an example embodiment, the PLCC switch 104 includes a total number of ports to be configured as input ports, output ports, or monitor ports. The switch controller 108 in a given switch may configure multiple ports to function as monitor ports 110 to be able to receive mirrored data from multiple input or output ports simultaneously.

The switch controller 108a-c may connect the monitor port 110 to the selected ports in predetermined time intervals such that each selected port is scanned at regular intervals or specific periods of time. The connection of the monitor port 110 to the selected ports may also be performed as periodic scans at one selected rate for all of the ports, and at another selected rate for selected ports where a particular analysis is needed of the signals at the selected ports. The PLCC switch 104a-c may provide information determined from analyzing replicated signals at the ports to the communication path management module 102 in periodic data transmissions, or in response to specific commands requesting specific information from the communication path management module 102.

The switch controller 108a-c may also continuously monitor signal levels and characteristics at each port through signal level and characteristics indicators on the receiver devices 122a-o and transmitter devices 124a-u. The switch controller 108a-c may report signal levels and characteristics to the communication path management module 102 either as part of periodic data reports or in response to specific commands requesting information.

In some implementations, the communication path management module 102 may designate selected paths as being secure paths, or as having specifications based, for example, on service level agreements. By obtaining the status of the communication paths, the communication path management module 102 may measure the compliance of each path with its designated specifications, and then perform indicated responsive measures. For example, communication paths deemed secure may be monitored for changes in signal level sufficient to indicate an attempt to tap into the communication path. When the communication path management module 102 is informed of such a change in signal level, the communication path management module 102 may send a command to the PLCC switches 104a-c to disable the path by disabling the links in the path. In another example, the communication path management module 102 may send commands to the PLCC switches 104a-c to obtain a latency measurement of selected communication paths. The communication path management module 102 may also maintain a port mapping of the communication paths interconnected by the PLCC switches 104a-c. A port mapping may be configured during initialization or during startup upon installation of the system 100, or upon modification by addition or subtraction of components to the system 100. The port mapping process may involve a self-identification process for each path that may be performed by interrogating individual ports in the PLCC switches 104a-c.

It is noted that the example in FIG. 1 shows the system 100 forming interconnections across 3 PLCC switches 104a-c. The 3 PLCC switches 104a-c are included in the system 100 for the purpose of providing a description of an example implementation. In other implementations, more or fewer than 3 PLCC switches may be used to configure any number of communication paths between any number of endpoints. A system may be configured to be as large or small in terms of numbers of endpoints and communication paths as needed for any given implementation. In some example implementations, a very large number of PLCC switches may be provisioned to provide a physical layer switch with high throughput and a high volume of interconnections of the type often required by data centers.

FIG. 2 is a block diagram of an example of a physical layer cross-connect switch PLCC switch 200 used in the system in FIG. 1. The PLCC switch 200 includes a cross-point switch 202, a switch controller 204, a cross-point control interface 206, a device controller 208, a management bus interface 214, and a storage medium 210. The PLCC switch 200 communicates with the communication path management module 102 (in FIG. 1) over the management bus 150 via the management bus interface 214. In an example implementation, the management bus 150 is a bus configured to communicate using Ethernet and the management bus interface 214 may be any suitable Ethernet interface. The management bus 150 may be configured to communicate using any suitable standard in other implementations.

The device controller 208 includes a processor for performing functions to provision, maintain, and monitor operation of the PLCC switch 200 according to programmed executable instructions stored in the storage medium 210. The device controller 208 receives commands from the communication path management module 102 (in FIG. 1) at the management bus interface 214. Based on the command, the device controller 208 configures, or obtains information from, the cross-point switches 202 via the cross-point control interface 206.

The cross-point control interface 206 connects to the cross-point switch 202 to communicate with a switch controller 204. The switch controller 204 provides control and port monitoring functions for the multiple ports P1-P24 in the cross-point switch 202. The cross-point switch 202 may include any suitable number of ports that may be configured as input ports, output ports, or monitor ports. Ports P1-P11 in FIG. 2 are configured to be input ports in the example in FIG. 2 while ports P12-P22 are configured to be output ports. Ports P23 and P24 are configured to operate as monitor ports 212a, 212b, respectively. In an example implementation, the switch controller 204 is a field-programmable gate array (FPGA) device programmed to perform functions as described herein.

Each input port P1-P11 is connected to a corresponding receiver device 216a-216k. Each output port P12-P22 is connected to a corresponding transmitter device 218a-218k. In example implementations, the receiver devices 216a-216k and the transmitter devices 218a-218k are transceivers configured in the implementation as either a receiving device or a transmitting device. In such example implementations, the transceivers may be configured as either receiving or transmitting, yet retain the capability of bi-directional communication. The receiver devices 216a-216k and the transmitter devices 218a-218k may be implemented using SFP, SFP+, QSFP, or QSFP+ devices, or using line cards, such as for example, RJ45 line cards.

The switch controller 204 connects to the monitor ports 212a, 212b configured to receive replicated signals communicated over a selected port or to transmit data to the selected port. The switch controller 204 may configure monitoring paths 230a and 230b between the selected ports and the monitor ports 212a and 212b. As shown in FIG. 2, the first monitoring path 230a is configured to receive replicated signals at the first monitor port 212a from port P17 while data signals are also communicated along the data path segment that traverses the selected port. FIG. 2 also shows the second monitoring path 230b configured to transmit data from the second monitor port 212b to port P15. Data transmission to a port such as port P15 as shown in FIG. 2 is performed in selected time intervals. Data may be transmitted from the monitor port 212b to any port, although ports that are linked to other ports must be unlinked before connecting to the monitor port 212b. The port (P15 in FIG. 2) may be re-linked as provisioned after the connection to monitor port 212b is removed.

Transmission of data to an input or output port may be performed in an intrusive diagnostic function, such as for example the path discovery function described below with reference to FIG. 7B. Examples of the types of information that may be obtained through the monitor port 212a in an example implementation include bit patterns to identify data streams, packet error rates (PER), data loss, time stamping receipt and/or transmission (for use in e.g., delay and/or jitter calculations), etc.

Information may be obtained through the monitor port 212a by performing a periodic scan of the selected ports in which the monitoring path 230 is connected to a mirrored copy of each port sequentially. For example, the switch controller 204 may be configured to scan each port connected to the monitor port 212a at every scan interval, Ts, where Ts may be any time interval deemed suitable for a given implementation. In some implementations, the Ts may be on the order of milliseconds, and in others it may be on the order of microseconds. In others, the scan interval Ts may be on the order of seconds.

Transceivers implemented using SFP or QSFP may provide continuous reporting of signal level via dedicated signaling lines, such as a device management bus 220 internal to the PLCC. In an example implementation, the switch controller 204 periodically polls the signaling lines via the device management bus 220 to continuously receive the status of the signal levels on the receivers/transmitters. The device management bus 220 may provide access, for example to a register device having dedicated bits to indicate the status of selected signaling lines. Re-timers may be used to recondition electrical inbound signals between an SFP module and a port. Re-timers can also report signal strength for twinax transceivers. Transceivers implemented using RJ45 line cards may include a PHY chip capable of reporting signal strengths. The device management bus 220 may be used to poll electrical transceivers, such as for example, RJ45 line cards for signal strength or other available information. The controller 204 may obtain information including optical or electrical signal levels, and other power level metrics.

It is noted that in some implementations, the signaling lines available for polling may be provided by the transceivers connected to the ports. It is to be understood that information provided by the transceivers may be retrieved by polling its corresponding port via the device management bus 220.

As noted above, the communication path management module 102 (in FIG. 1) may send commands to the PLCC switch 200 over the management bus 150. The commands are received by the device controller 208 for parsing, translating or transmitting commands to send to the switch controller 204 in the cross-point switches 202. The switch controller 204 performs the functions involved in executing the commands. The switch controller 204 also provides responsive information where the commands entail information to be communicated back to the communication path management module 102. Example commands include commands involving the configuration of data path segments to form links in forming communication paths are communicated to the switch controller 204 to connect a designated input port (e.g. port P1) to the designated output port (e.g. port P12). Execution of a configuration command results in the formation of a data path segment 226 of the type illustrated in FIG. 2.

Commands involving a request for information are communicated to the switch controller 204 to retrieve the requested information or information from which the requested information may be derived. The switch controller 204 analyzes mirrored signals communicated to the monitor port 212a to determine the information requested by the command. The switch controller may also receive information from the transceivers via the device management bus 220. The information may be simply a signal level from a transceiver at a selected port. The information may require analyzing the data received at the monitor port 212a to identify a bit pattern of the signal from the selected port.

One example of a command requesting information from the switch controller 204 is a command to perform a latency measurement. In measuring latency of a communication path, the communication path management module 102 (in FIG. 1) sends a command to the PLCC switch (e.g. PLCC switch 104a in FIG. 1) that has the first port in the communication path (i.e., and ingress PLCC) to initiate a latency measurement. The command may be provided with a bit pattern, or packet value to inject into the port. The first PLCC switch 104a receives the command and initiates a latency measurement. The latency measurement may be initiated by waiting a small amount of time for setup of the measurement. For example, the path management module 102 may send a command to the last port (in a different PLCC switch) to command it to set up a loopback. The loopback may be implemented by connecting the output of the receiver of last port to the input of the transmitter of the same port on the data path segment 226. Further, the ingress PLCC may also start a timer. The switch controller 204 of the ingress PLCC then senses for the bit pattern returning at the designated port, and recording an elapsed time for the bit pattern to return on the communication path for which the designated port is the first input port. When the switch controller 204 detects the bit pattern returned from the last port on the last PLCC switch in the communication path, the first PLCC switch 200 in the communication path determines the elapsed time since injecting the bit pattern into the port. The elapsed time divided by two is the latency measurement of the communication path returned to the communication path management module 102 as a response to the command requesting a latency measurement.

Once the switch controller 204 determines the information requested in a command from the communication path management module 102, the information is provided in a data path report message formatted for transmission to the communication path management module 102 via management bus 150. Data path report messages may be generated for data returned in response to a command requesting the information. Data path report messages may also be generated pursuant to data scans. For example, the switch controller 204 may scan selected ports via the monitor port 212a at selected time intervals to obtain desired signal characteristics for the signals at the selected ports. The switch controller 204 generates the information relating to the signal characteristics for transmission to the communication path management module in a data path report message. The data path report messages may be configured by the switch controller 204, or by the device controller 208 before transmission over the management bus 150.

FIG. 3 is a table illustrating an example port mapping 300 for the physical layer switch system illustrated in FIG. 1. The communication path management module 102 may configure the port mapping 300 by requesting construction of each communication path by starting with information concerning the connections between the PLCC switches in the system and sending commands to form links in each PLCC switch that connects one endpoint to another endpoint. The endpoints and ports identified in each device for each communication path are then stored in the port mapping 300 to define each path. In another embodiment, the system may also utilize a cable interconnect table that identifies a PLCC device and port number associated with each end of a cable. The interconnect table may then be used to identify possible paths from a first location (e.g., a first PLCC having a link to a data center ingress/egress point) to a second location (e.g., a PLCC having a link to a desired rack location), where the possible paths may traverse multiple PLCCs and cables.

In another embodiment, the communication path management module 102 in FIG. 1 may be installed in a system in which all of the communication paths have already been formed. On the first initialization of the communication path management module, the communication path management module may perform a process of path discovery involving interrogating the PLCC switches to determine sequences of ports forming different paths. The port mapping 300 may be configured as communication paths are provisioned. For example, the communication path management module may be used during provisioning of service in a data center, for example. The port mapping 300 may need to be revised whenever changes are made to the system 100 in FIG. 1, such as for example when a PLCC switch 104a-c is added or removed.

The port mapping 300 defines each communication path to be maintained by the communication path management module. A most basic definition of each path would be based on the endpoints connected by the path and each port traversed by the path as shown in the port mapping 300 in FIG. 3. Referring to FIG. 1 and FIG. 3, the first path in the port mapping 300 in FIG. 3 connects endpoint EP1 120a to endpoint EP5 120e shown in FIG. 1. The path is defined as starting at endpoint EP1 and comprising the data path segment 128 (in FIG. 1) connecting P1 to P7 in the first PLCC switch 104a in FIG. 1 (shown as “Dev1” in FIG. 3). The second data path segment in the first path connects P1 to P6 in Dev2 (the second PLCC switch 104b in FIG. 1). The third data path segment in the first path connects P1 to P6 in Dev3 (the third PLCC switch 104c in FIG. 1). The next path in the port mapping 300 connects endpoint EP2 120b to endpoint EP6 120f in FIG. 1 using data path segment 1, data path segment 2, and data path segment 3 as shown in the port mapping 300. The rest of the table shows paths formed between endpoint EP3 120c and endpoint EP7 120g, endpoint EP4 120d and endpoint EP10 120j with the corresponding links forming each path.

In another implementation, the port mapping 300 may include additional information about each communication path. For example, the port mapping 300 may also include specifications (such as, for example, service level agreements (SLA)), prior measurements of selected characteristics (such as, for example, latency), and a status indicator (indicating for example, if the path is active, inactive, disabled, secure, highly available, and other suitable status indications).

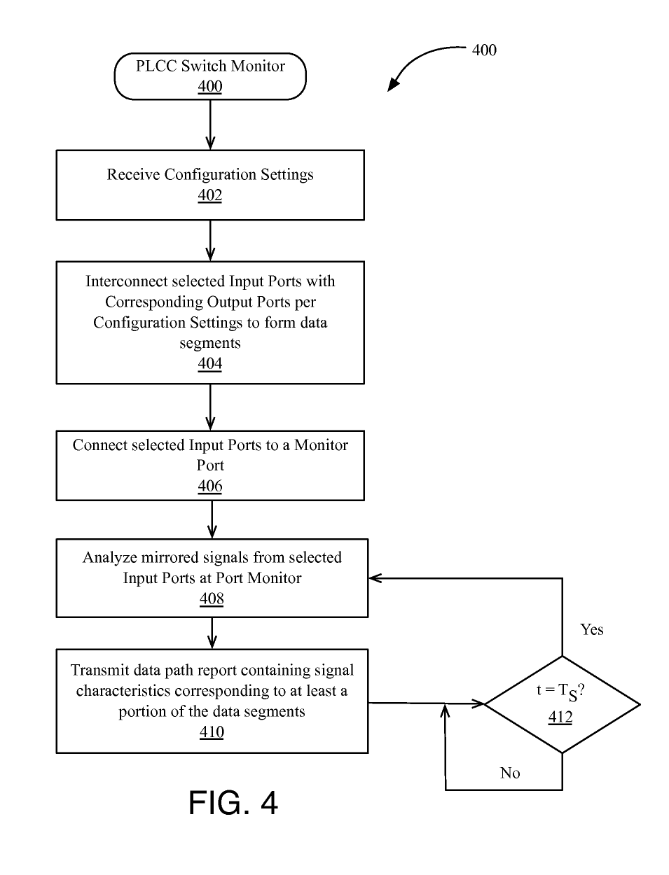

As noted above, the switch controller 204 in the PLCC switch 200 may operate in a continuous scan mode in which characteristics of mirrored signals are collected via the monitor port 212a. This form of monitoring of the communication paths is considered non-intrusive since the scan of the replicated signals is performed as the signals simultaneously continue along their communication paths. FIG. 4 is a flowchart illustrating operation of an example method 400 for performing non-intrusive signal monitoring.

The method 400 illustrated in FIG. 4 may be performed by the switch controller 204 in the PLCC switch 200. At step 402 of the method 400, the PLCC switch 200 in FIG. 2 receives configuration settings from the communication path management module 102 in FIG. 1. The configuration settings may be for a new communication path, or for a number of communication paths. At step 404, the ports to be connected in the path are interconnected to form the desired path per the configuration settings. It is noted that steps 402 and 404 may or may not be performed in initiating a continuous scan.

At step 406 of the flowchart in FIG. 4, selected input ports are sequentially connected to the monitor port 212a (in FIG. 2). The ports selected for monitoring may be selected on the basis of their inclusion in a communication path, which is known from having received configuration settings to create the communication path. The monitor port 212a (in FIG. 2) is connected to each port for a predetermined amount of time in a sequence. The replicated signal is collected at the connected port for the predetermined amount of time and the connection to the monitor port 212a is switched to the next port. The process repeats for the next port, and the port after the next.

At step 408, replicated signals communicated at the selected ports are analyzed. The replicated signals may be analyzed by the switch controller 204 using layer 2 level metrics. The analysis performed in step 408 may involve recording data scans, detecting bit patterns, determining packet error rates (PER), determining a bit error rate (BER), a parity check, data loss, time stamping receipt and/or transmission (for use in e.g., delay and/or jitter calculations), etc. In an example embodiment, the switch controller 204 may identify a block of data in the signal and perform a cyclic redundancy check (CRC) on the block of data.

In an example embodiment, the switch controller 204 polls its ports or transceivers using the device management bus 220 in addition to detecting signal characteristics via monitor port scans. The switch controller 204 may poll its ports or transceivers to obtain signal level or signal conditions that may be provided by the transceivers. Examples of signal characteristics that may be measured or determined by the switch controller 204 (in FIG. 2) by way of polling using the device management bus 220 include, without limitation and depending on characteristics available, signal strength, signal level (e.g. light or electrical level), fault indication, and other similar parameters. The polling of ports or transceivers over the device management bus 220 may be performed contemporaneously with port mirroring at the monitor port 212a. In one embodiment, for example, polling of ports may be performed each time a port is also mirrored via the monitor port. The polling of ports may also be performed periodically independent of port mirroring, or in response to a request for information from, for example, the communication path management module 102 (in FIG. 1).

At step 410, the switch controller 204 (in FIG. 2) transmits a data path report containing the measured signal characteristics. The data path report may contain data for all selected ports, or for a selected set of the selected ports. In embodiments in which the signal controller 204 performs a CRC check on a detected block of data, the results of the CRC and the block of data may be communicated as the detected signal characteristics. The data path report may also include signal characteristics determined from polling ports or transceivers.

In some embodiments a scan time parameter Ts is used. At decision block 412, the time is checked to determine if a scan time, Ts, has elapsed. If not, the switch controller 204 waits for the time Ts. If Ts has elapsed, another scan is performed by analyzing replicated signals from the selected ports at step 408.

The cycle indicated in FIG. 4 for scanning the ports on the PLCC switch 200 (in FIG. 2) may continue for as long as necessary, or simply continuously as a basic function of the switch controller 204 (in FIG. 2).

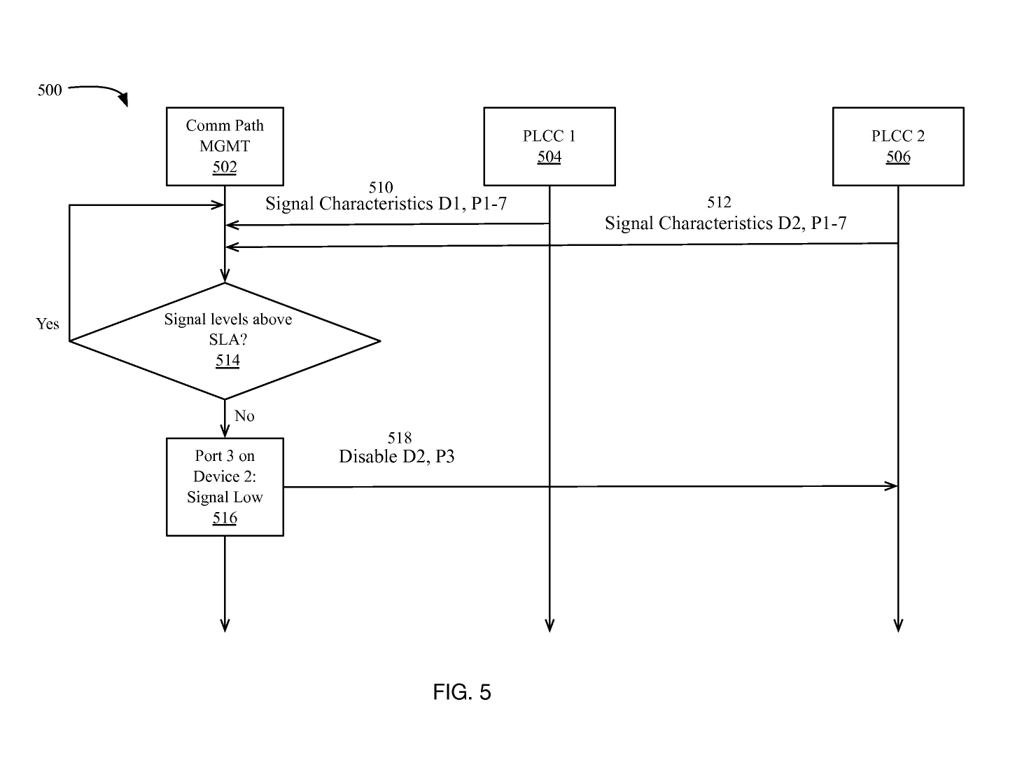

FIG. 5 is a flowchart illustrating operation of an example method 500 for monitoring a signal along a secure communication path formed by a network of physical layer switches. The method 500 in FIG. 5 is performed by interaction between a communication path management module 502, a first PLCC switch 504, and a second PLCC switch 506. The flowchart in FIG. 5 shows steps performed by each component along corresponding timelines with messages exchanged at appropriate times in the timelines. Message 510 in FIG. 5 is a message communicated by the first PLCC switch 504 reporting signal characteristics for device DEV1, ports P1-P7. The message 510 may be configured by the switch controller of the first PLCC switch 504 upon performing the method 400 shown in FIG. 4. The message 510 may also include signal characteristics obtained by polling ports over the device management bus 220 (in FIG. 2). Message 512 is a message communicated by the second PLCC switch 506 reporting signal characteristics for device DEV2, ports P1-P7. Messages 510 and 512 are communicated to the communication path management module 502.

At decision block 514, the communication path management module 502 determines if any of the signal levels reported for the first PLCC switch 504 or the second PLCC switch 506 are out of specification for the paths traversed by the ports reported. The specification for the signal levels may be determined by service level agreements governing the communication path between the endpoints, by any special designation of the communication path (e.g. Secure Path, High-Availability Path, High-Throughput Path, etc.).

If at decision block 514, signal levels or characteristics are not out of specification (the “NO” path), control returns to receiving messages 510 and 512 for new signal levels to test. If decision block 514 determines that one or more signals are out of specification (the “YES” path), the communication path management module 102 (in FIG. 1) may send a command to the PLCC switch containing the port reporting the out of spec signal for execution of appropriate remedial action. In the example shown in FIG. 5, Port 3 on device 2 reported a low signal level at step 516. If the path traversed by port 3, device 2 is designated as secure, the communication path management module 102 (in FIG. 1) may send a disable command 518 as shown in FIG. 5. The communication path management module 102 may follow-up with other appropriate action, such as communication of a warning alert to a user interface. Depending on the specific fault determined, the communication path management module 102 may initiate a re-routing process to determine an alternative communication path between the two endpoints.

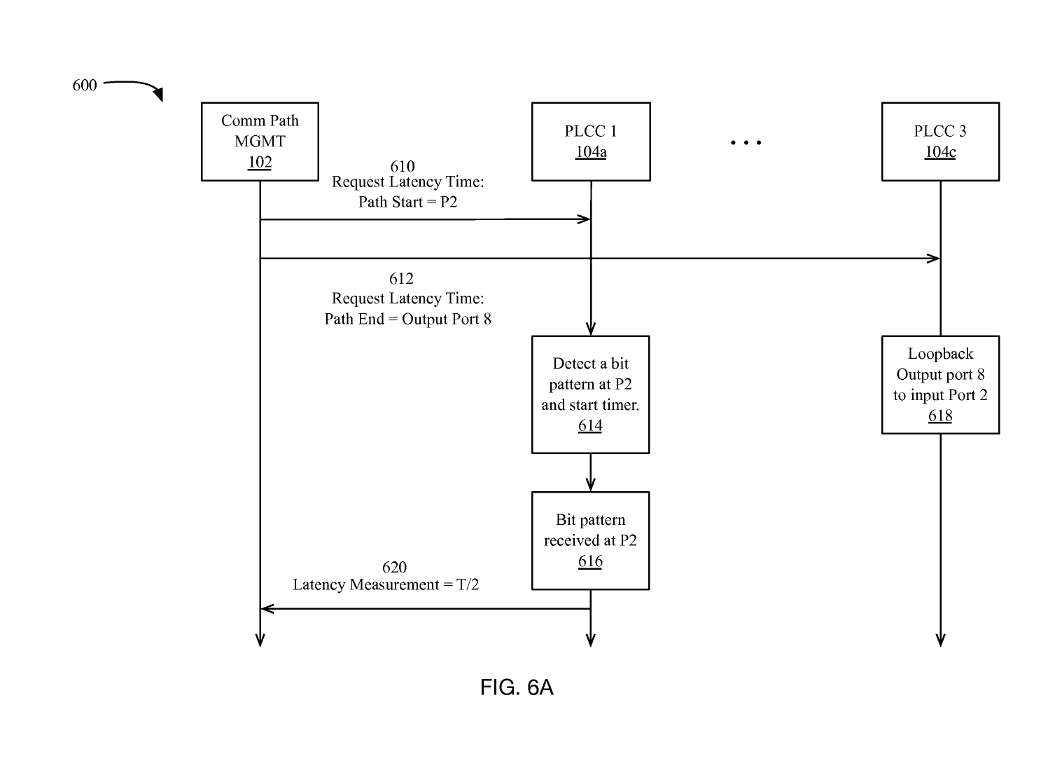

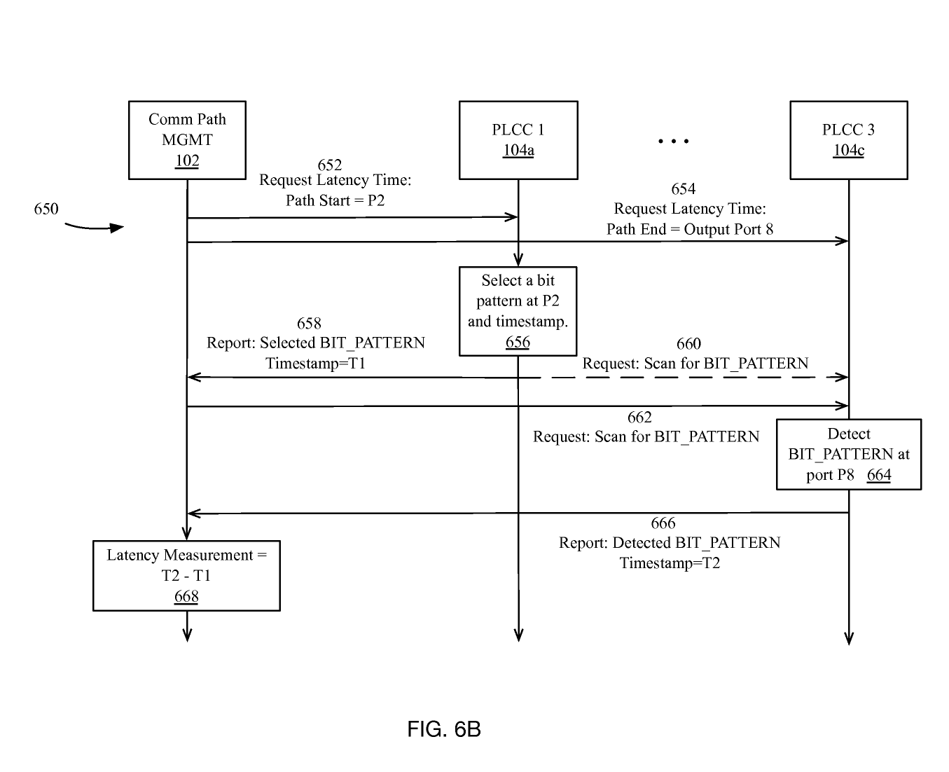

One example of a performance measurement that the communication path management module 102 (in FIG. 1) may request from the PLCC switches 104a-c (in FIG. 1) is a latency measurement. FIG. 6A is a flowchart illustrating operation of an example method for measuring latency in a network of physical layer switches. The method 600 in FIG. 6A is performed by interaction between the communication path management module 102, the first PLCC switch 104a, and the third PLCC switch 104c in the network in FIG. 1. The flowchart in FIG. 6A shows steps performed by each component along corresponding timelines with messages exchanged at appropriate times in the timelines. The example shown in FIG. 6A assumes that the communication path for which latency is being measured has port P2 in PLCC 1 104a as the first port in the communication path and port P8 in PLCC 3 104c as the last port in the communication path. This path connecting EP2 and EP6 is the second path listed in the table in FIG. 3. The last port, port P8, is configured during the test as an output port connected to input port P2 in device PLCC 3 104c. As the first port in the path, port P2 in PLCC 1 104a is connected to a receiver device connected to the second endpoint 120b. As the last port in the path, port P8 in PLCC 3 104c is connected to a transmitter device connected to the opposite endpoint, endpoint 6 120f, in the path. It is noted that the communication path management module 102 would know the ports and devices forming the communication path by reference to a port mapping, such as for example, the port mapping 300 in FIG. 3.

The latency measurement is started in FIG. 6A by message 610 sent by the communication path management module 102 to PLCC 1 104a. Message 610 contains a command requesting latency measurement of path starting at port P2 on PLCC 1 104a. The communication path management module 102 also sends a message 612 to PLCC 3 104c containing the command requesting a latency measurement for the path ending at port P8 on PLCC 3 104c.

PLCC 1 104a begins the latency measurement by determining a bit pattern to communicate on the communication path at the start of the measurement. The bit pattern may be designated by the communication path management module 102 in the latency measurement command, and injected at port P2 of PLCC 1 104a. The bit pattern may also be a bit pattern in the signal communicating on the path that is detected at a start time of the measurement. The bit pattern is determined and communicated on the path as a timer is started at step 614 in FIG. 6A. The PLCC 3 device receives the command requesting latency measurement and responsively loops the designated output port, port P8, back to its input port, P2 at step 618. When the bit pattern communicated in the path from step 614 is received at port P8 on device PLCC 3 104c, the bit pattern is looped back through the path towards the first port, input port P2 on PLCC 1 104a in the path. At step 616, PLCC 1 104a detects the bit pattern received at port P2 and stops the timer. PLCC 1 104a then communicates a message 620 containing the elapsed time divided by 2 as the measured latency time.

It is noted that the method 600 for latency measurement described with reference to FIG. 6A is an intrusive method because it requires interruption of data traffic on the path being tested. FIG. 6B is a flowchart illustrating operation of an example non-intrusive method 650 for measuring latency in a network of physical layer switches. In the method 650 in FIG. 6B, the latency measurement of a known path with known endpoints is to be measured non-intrusively so that data traffic along the path is not interrupted.

The method 650 in FIG. 6B is performed by interaction between the communication path management module 102, the first PLCC switch 104a, and the third PLCC switch 104c in the network in FIG. 1. The flowchart in FIG. 6B shows steps performed by each component along corresponding timelines with messages exchanged at appropriate times in the timelines. The example shown in FIG. 6B determines the latency of the path used as an example in the method 600 in FIG. 6A.

The communication path management module 102 initiates a latency measurement by sending a command at 652 to PLCC 1 104a, which contains the first port, port P2, in the path for which latency is being measured. The latency measurement command 652 requests a latency measurement for the path starting at port P2 of PLCC 1 104a. The command path management module 102 also sends a command to PLCC 3 104c to scan data at port P8, the last port in the path for which latency is being measured, for a latency measurement. Responsive to the latency measurement command from the communication path module 102, PLCC 1 104a selects a bit pattern at step 656 from the data traffic streaming through port P2 of PLCC 1 104a and obtains a timestamp indicating the time the bit pattern was detected at P2 of PLCC 1104a. PLCC 1104a then reports the detected bit pattern with a time stamp, for example, time=T1, indicating the time at which the bit pattern was detected at port P2 of PLCC 1 104a. The command path management module 102 may then send a command to PLCC 3 104c requesting that the PLCC 3 104c scan the data stream at port P8 for the selected bit pattern. In an alternative implementation (indicated by dashed arrow at 660), PLCC 1 104a may communicate the bit pattern to be scanned by PLCC 3 104c directly to PLCC 3 104c at 660.

At step 664, PLCC 3 104c detects the selected bit pattern at port P8. Depending on the timing of the messages, the detection of the bit pattern may be performed by scanning a bit stream recorded from a scan at port P8. A time stamp indicating the time, for example t=T2, at which the bit pattern was detected is determined and communicated with the bit pattern to the communication path management module 102 at 666. The communication path management module 102 receives the time stamp for the detection of the bit pattern by PLCC 3 104c in message 666 and determines the latency measurement as T2−T1.

In an example implementation, the communication path management module 102 (in FIG. 1) may need to verify the PLCC switches and ports forming one or more communication paths. The communication path management module 102 may also need to discover paths when initialized for operation for the first time. The communication path management module 102 (in FIG. 1) may initiate a port self-identification or a path self-discovery process to verify the port mapping. The path self-discovery process may be intrusive in that data flow through the paths is disabled, or non-intrusive in that data may continue to flow through the paths during the process.

FIG. 7A is a flowchart illustrating operation of an example intrusive method 700 for interrogating a network of physical layer switches to identify used and unused paths in a network of physical layer switches. The method 700 in FIG. 7A is performed by interaction between the communication path management module 102, the first PLCC switch 104a, the second PLCC switch 2 104b, and PLCC switch 3 in the network shown in FIG. 1. The flowchart in FIG. 7A shows steps performed by each component along corresponding timelines with messages exchanged at appropriate times in the timelines. The example shown in FIG. 7A is performing self-discovery for a path that may be formed with port P5 in PLCC 1 104a as the first port in the communication path. The last port in the path is technically unknown or at least assumed to be unknown at this point in the process. It is noted that the communication path management module 102 may know the ports and devices forming the communication path by reference to a port mapping, such as for example, the port mapping 300 in FIG. 3. Method 700 may be performed for purposes of verifying a port mapping, or for updating the port mapping. In some implementations, the method 700 in FIG. 7A may be used to generate the port mapping. As an intrusive process, the method 700 in FIG. 7A may find particular use for discovering paths in a new installation of a communication path management system.

The method 700 in FIG. 7A begins with a command in message 702 from the communication path management module 102 to the first PLCC switch 1 104a. The command in message 702 requests discovery of a path starting at port P5 of PLCC 1104a. The command may include a power cycle pattern in the form of, for example, a bit pattern that PLCC 1104a will use to initiate path self-discovery. The communication path management module 102 sends a broadcast command in messages 704 to all downstream PLCC switches (PLCC 2 through PLCC 3) requesting a report upon detection of the power cycle pattern at any of the ports on each device. At step 706, PLCC 1 cycles the power on port P5 according to the power cycle pattern provided in the path discovery command in a manner analogous to a Morse code transmission. In an example implementation in which optical modules, such as for example, SFP, SFP+, or QSFP modules, are used as transceivers, the switch controller in the PLCC 1 104a may disable and enable the transmit line, tx, in the indicated power cycle pattern. The disabling of the transmit line, tx, turns the laser light source off in the transceiver connected to port P5. A register may also be implemented to permit toggling of the laser power via the device management bus 220 (in FIG. 2). In an example implementation in which electrical transceiver modules (e.g. RJ 45 modules) are used, the power of a PHY chip may be toggled in the indicated power cycle pattern.

Each PLCC switch then tests each of its ports for a power profile matching the power cycle pattern generated at port P5 on PLCC 1 104a. PLCC 2 104b tests each port at step 708 by polling each port or transceiver to detect a pattern of signal power loss at the port. PLCC 3 104c also tests its ports for the power cycle pattern at step 710 by polling its ports or transceivers using for example, the device management bus 220 (in FIG. 2). It is noted that the detection of the pattern of signal power loss at a given port may require multiple polls of the port. The ports may be polled repeatedly for a time period sufficient to enable the detection of the pattern of the cycling of the signal power.

At decision block 712, PLCC 2 104b determines if the power cycle pattern was detected at any port on PLCC 2 104b. If the power cycle pattern was detected at any port on PLCC 2 104b, the device identifier and ports detecting the power cycle pattern are reported to the communication path management module 102 at step 716. At decision block 714, PLCC 3 104c determines if the power cycle pattern was detected at any port on PLCC 3 104c. If the power cycle pattern was detected at any port on PLCC 3 104c, the device identifier and ports detecting the power cycle pattern are reported to the communication path management module 102 at step 718. The PLCC 2 104b and PLCC 3 104c may report their device identifier and ports that detected the power cycle pattern on messages 720 to the communication path module 102. PLCC 2 104b reports the power cycle pattern was detected at ports P5 and P12 on PLCC 2 104b. PLCC 3 104c reports the power cycle pattern was detected at ports P5 and P12 on PLCC 3 104c.

At step 722, the communication path management module 102 identifies each of the devices and corresponding ports that detected the power cycle pattern initiated at step 706. The devices and ports identified in step 722 may indicate links forming a communication path. At step 724, the communication path management module 102 determines if the devices and ports identified in step 722 form any paths of any length. The paths identified may be end to end paths, or partial paths not extending end to end. The information regarding end-to-end paths and partial paths may be useful to the communication path management module 102 in configuring communication paths.

The communication path management module 102 may also determine if a path is valid. The validity of the path may be based on information about the network of PLCC switches that is already known to the communication path management module 102. For example, the path being tested may be compared with other known paths (from a port mapping, for example) to determine if the path under test intersects with a known path in an invalid manner. Two paths may have a common endpoint and begin with a common path emanating from the endpoint then divide at some further point to terminate distinct endpoints. Otherwise, two paths may not share ports. Other factors determining validity include whether a path is open between endpoints, or whether a path does not terminate at an endpoint. If the path under test is valid, the path is added to a port mapping. If the path is not valid, a partial path may be identified.

FIG. 7B is a flow diagram illustrating another intrusive process for path self-discovery. In the example shown in FIG. 7B, the communication path management module 102 sends a message 732 requesting path self-discovery at port P5 of PLCC 1 104a to PLCC 1 104a. The switch controller 108a (in FIG. 1) in PLCC 1 104a also selects one or more test packets to transmit to port P5 via the monitor port 110 (in FIG. 1). The test packets may be an identifier for the PLCC 1 104a, or any other suitable message. The PLCC 1 104a broadcasts messages 734 to the other PLCC's requesting that the PLCC's monitor their ports by recording a signal at each port starting at a start time for a predetermined period of time. The broadcast messages 734 also includes the test packets that should be searched in the data recorded at each port.

At step 736, the switch controller 108a on PLCC 1 104a transmits the test packet for a time period sufficient to allow recording of the test packets in data recorded at the ports of the other PLCC switches. The PLCC 1 104a may also transmit a message 738 to the communication path management module 102 responsive to the request for path self-discovery. The message 738 may simply acknowledge the request for path self-discovery and provide the test packets transmitted through port P5 as well as the start time of the transmission.

At step 740, PLCC 2 104b records data flowing through each of its ports. At step 742, PLCC 3 104c records data flowing through each of its ports. The switch controllers 108b and 108c in PLCC 2 104b and PLCC 3 104c may connect the monitor port 110 (in FIG. 1) to each of their ports to receive the data at each port over a predetermined time period. The PLCC 2 104b and PLCC 3 104c may each have more than one monitor port 110 configured to receive data from the ports. For example, the PLCC 2 104b may have three monitor ports allowing the switch controller to record data from three ports at a time for preselected scan times.

At step 744, PLCC 2 104b searches the data recorded in step 740 for the test packets transmitted by PLCC 1 104a at port P5. PLCC 2 104b sends a message 750 reporting the test packets detected and identifying the device ID of PLCC 2 104b as well as the ports at which the test packets were detected. In the example shown in FIG. 7B, PLCC 2 104b reports that the test packets were detected at ports P5 and P12.

At step 746, PLCC 3 104c searches the data recorded in step 742 for the test packets transmitted by PLCC 1 104a at port P5. PLCC 3 104c sends a message 752 reporting the test packets detected and identifying the device ID of PLCC 3 104c as well as the ports at which the test packets were detected. In the example shown in FIG. 7B, PLCC 3 104c reports that the test packets were detected at ports P5 and P12.

The communication path management module 102 may wait for a period of time for all PLCC's in the system to report results to the request for path self-discovery. At step 754, the communication path management module 102 identifies all ports and devices that detected the test packets transmitted into the path at port P5 on PLCC 1 104a. At step 756, the communication path management module 102 identifies any paths formed by the ports identified in step 754. The communication path management module 102 may then use the path information from step 754 to further map ports and determine partial paths and valid paths available for path configuration.

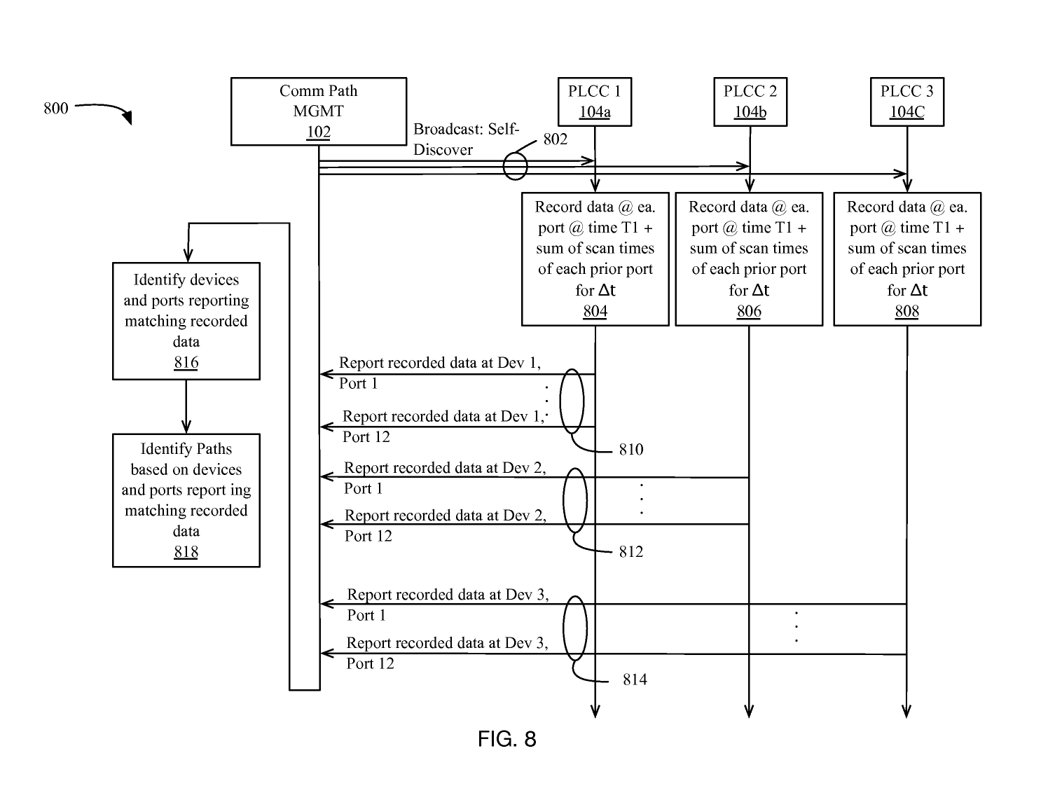

A non-intrusive method 800 for path self-discovery is illustrated in FIG. 8. In the method 800 shown in FIG. 8, the communication path management module 102 broadcasts a path self-discovery command 802 to the PLCC's in the system. In the example in FIG. 8, the path self-discovery command is received by PLCC 1 104a, PLCC 104b, and PLCC 3 104c. The path self-discovery command may include a start time. When the command is received, each PLCC switch 104a-c records data at each port for a predetermined period of time, T1. At step 804, PLCC 1 104a records data at each port on PLCC 1 104a starting at time T1. The PLCC 1 104a receives data at each port over the monitoring path 130 connection to the monitor port 110 (in FIG. 1). The monitor port 110 may be connected to each port for a scan time, TS, and the ports may be continuously and sequentially scanned for a predetermined length of time, Δt, sufficient to capture a data pattern that can be matched with data patterns collected at ports on all of the PLCC's. The PLCC switches 104a-c may configure multiple monitor ports. At step 806, PLCC 2 104b records data at each port on PLCC 2 104b. At step 808, PLCC 3 104c records data at each port on PLCC 3 104c. It is noted that the data recorded at each port constitutes data flowing through the communication paths during normal operation. That is, the data constitutes data transmitted from one endpoint to another.

When PLCC 1 104a has completed the data recording at each port for the predetermined period of time Δt, PLCC 1 104a transmits messages 810 to the communication path management module 102 reporting the recorded data at each port on the device. Similarly, PLCC 2 104b transmits messages 812 to the communication path management module 102 reporting the recorded data at each port on the device. PLCC 3 104c too transmits messages 814 to the communication path management module 102 reporting the recorded data at each port on the device.

The communication path management module 102 may wait a predetermined time period for all PLCC switches to report recorded data at each of their ports. At step 8116, the communication path management module 102 compares the recorded data from each of the ports on each of the PLCC switches to identify matching patterns in the recorded data. For example, the communication path management module 102 may compare the recorded data from port P5 of PLCC 1104a with recorded data from ports on PLCC 2 104b and find a match in recorded data from ports P5 and P12 on PLCC 2 104b. The communication path management module 102 may continue comparing the data recorded at P5 of PLCC 1104a with data recorded at the ports of PLCC 3 104c and find a match in recorded data from ports P5 and P12 of PLCC 3 104c. At step 818, the communication path management module 102 may use the information regarding devices and ports with matching recorded data to identify paths.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
receiving configuration settings from a communication path management module and responsively forming a plurality of data path segments by configuring a physical layer cross-connect (PLCC) switch to interconnect each of a plurality of input ports adapted to receive signals via corresponding receivers to a respective plurality of output ports adapted to transmit signals via corresponding transmitters, wherein each data path segment comprises a receiver, an input port, at least one output port and at least one transmitter;
selecting a series of selected input ports of the plurality of input ports and interconnecting each of the series of selected input ports to at least one monitor port while simultaneously maintaining interconnections of the data path segments;
analyzing replicated signals received at the monitor port to determine signal characteristics; and
transmitting data path report messages containing the signal characteristics corresponding to at least a portion of the plurality of data path segments.

2. The method of claim 1, further comprising:
repeatedly performing the steps of analyzing the replicated signals and transmitting the signal characteristics to the communication path management module.

3. The method of claim 1, further comprising:
polling at least one input port to determine a signal strength at the at least one input port; and
communicating the signal strength for each of the at least one input port to the communication path management module.

4. The method of claim 3, wherein the step of determining the signal strength comprises receiving a signal strength indication from the receiver or transmitter connected to the selected port.

5. The method of claim 1, wherein a selected one of the plurality of input ports is a first port in a first data path segment forming a selected end-to-end communication path traversing at least one other PLCC switch to a last port in a last data path segment, the method further comprising the steps of:
receiving a request for a latency measurement of the selected end-to-end communication path;
in response to receiving the request for the latency measurement, connecting the selected one of the plurality of input ports to the at least one monitor port;
identifying a bit pattern received at the monitor port from the selected one of the plurality of input ports and starting a timer marking a first receipt of the bit pattern, wherein the bit pattern is communicated on the selected end-to-end communication path and looped back from the last port in the last data path segment;
receiving the bit pattern a second time at the monitor port from the selected one of the plurality of input ports;
determining a time from the first receipt of the bit pattern until the second receipt of the bit pattern;
identifying the time divided by 2 as the latency measurement; and
communicating the latency measurement as the signal characteristic.

6. The method of claim 1, further comprising:
receiving a request for a latency measurement for a selected end-to-end communication path, the request identifying a selected input port in the PLCC switch as being a first input port in the selected end-to-end communication path, wherein the request for the latency measurement is also communicated to a second PLCC switch having a last output port in the selected end-to-end communication path;
connecting the monitor port to the selected input port;
selecting a bit pattern at the monitor port from the data being communicated at the selected input port and marking a time the bit pattern was received;
sending the bit pattern to the second PLCC switch, wherein the second PLCC switch searches for the bit pattern at the last output port in the selected end-to-end communication path and marks the time the bit pattern was received at the last output port; and
sending the bit pattern and time the bit pattern was received to the communication path management module to determine the latency measurement as the time elapsed from the bit pattern receipt at the first input port of the selected end-to-end communication path and the bit pattern receipt at the last output port in the selected end-to-end communication path.

7. The method of claim 1, wherein a PLCC switch traversed by a selected end-to-end communication path is commanded to turn a selected port on and off in a predetermined power cycle pattern, the method further comprising:
receiving a request to detect a signal power level changing in the predetermined power cycle pattern at any input port;
polling each input port to detect the signal power level changing in the predetermined power cycle pattern;
identifying the input port at which the predetermined power cycle pattern was detected; and
reporting the input port at which the predetermined power cycle pattern was detected to the communication path management module.

8. The method of claim 1, wherein the PLCC switch is traversed by end-to-end communication paths that traverse at least one other PLCC switch, the method comprising:
receiving a path discovery request to discover a communication path traversing a selected one of the plurality of input ports;
determining a test packet to transmit at the selected one of the plurality of input ports;
broadcasting a request to the at least one other PLCC switch to record data at each port on the at least one other PLCC switch and to search for the test packet in the recorded data;
connecting the monitor port to the selected one of the plurality of input ports; and
transmitting the test packet at the selected one of the plurality of input ports via the monitor port, wherein each of the at least one other PLCC switch reports each port at which the test packet was detected to the communication path management module for identification of a path traversing the selected one of the plurality of input ports.

9. The method of claim 1, wherein the PLCC switch is traversed by end-to-end communication paths that traverse at least one other PLCC switch, the method comprising:
receiving a request to discover paths traversing the PLCC switch, wherein the request is broadcast to the at least one other PLCC switch;
connecting each of the plurality of input ports to the at least one monitor port for a scan time;
recording data received at each of the plurality of input ports; and
communicating the recorded data to the communications path management module for matching of recorded data to determine paths through the PLCC switch.

10. The method of claim 1, wherein the step of analyzing the replicated signals comprises:
identifying a block of data in the replicated signals;
performing a cyclic redundancy check (CRC) on the block of data; and
communicating the CRC result and block of data as the signal characteristic.

11. A physical layer cross-connect switch comprising:
a plurality of input ports connected to corresponding receivers;
a plurality of output ports connected to corresponding transmitters;
a switch controller connected to control the plurality of input and output ports, the switch controller comprising a processor, and a non-transitory computer-readable medium storing executable instructions that, when executed by the processor, are operative to:
receive configuration settings from a communication path management module;
interconnect each of the plurality of input ports to respective ones of the plurality of output ports to form a plurality of data path segments each comprising a receiver, an input port, at least one output port and at least one transmitter;
sequentially select a series of selected input ports of the plurality of input ports and interconnecting each of the series of selected input ports to at least one monitor port while simultaneously maintaining interconnections of the data path segments;
analyze replicated signals received at the monitoring port to determine signal characteristics; and
transmit data path report messages containing the signal characteristics corresponding to at least a portion of the plurality of data segments.

12. The physical cross-connect switch of claim 11, wherein the non-transitory computer-readable medium stores executable instructions that, when executed by the processor, are operative to:
repeatedly perform the steps of analyzing the replicated signals and transmitting the signal characteristics to the communication path management module.

13. The physical cross-connect switch of claim 11, wherein the non-transitory computer-readable medium stores executable instructions that, when executed by the processor, are operative to:
poll at least one input port to determine a signal strength at the at least one input port; and
communicate the signal strength for each of the at least one input port to the communication path management module.

14. The physical cross-connect switch of claim 11, wherein the non-transitory computer-readable medium stores executable instructions that, when executed by the processor, are operative to:
receive a signal strength indication from the receiver or transmitter connected to the selected port.

15. The physical cross-connect switch of claim 11, wherein a selected one of the plurality of input ports is a first port in a first data path segment forming a selected end-to-end communication path traversing at least one other PLCC switch to a last port in a last data path segment, and wherein the non-transitory computer-readable medium stores executable instructions that, when executed by the processor, are operative to:
receive a request for a latency measurement of the selected end-to-end communication path;
in response to receiving the request for the latency measurement, connect the selected one of the plurality of input ports to the at least one monitor port;
identify a bit pattern received at the monitor port from the selected one of the plurality of input ports and starting a timer marking a first receipt of the bit pattern, wherein the bit pattern is communicated on the selected end-to-end communication path and looped back from the last port in the last data path segment;
receive the bit pattern a second time at the monitor port from the selected one of the plurality of input ports;
determine a time from the first receipt of the bit pattern until the second receipt of the bit pattern;
identify the time divided by 2 as the latency measurement; and
communicate the latency measurement as the signal characteristic.

16. The physical cross-connect switch of claim 11, wherein the non-transitory computer-readable medium stores executable instructions that, when executed by the processor, are operative to:
receive a request for a latency measurement for a selected end-to-end communication path, the request identifying a selected input port in the PLCC switch as being a first input port in the selected end-to-end communication path, wherein the request for the latency measurement is also communicated to a second PLCC switch having a last output port in the selected end-to-end communication path;
connect the monitor port to the selected input port;
select a bit pattern at the monitor port from the data being communicated at the selected input port and marking a time the bit pattern was received;
send the bit pattern to the second PLCC switch, wherein the second PLCC switch searches for the bit pattern at the last output port in the selected end-to-end communication path and marks the time the bit pattern was received at the last output port; and
send the bit pattern and time the bit pattern was received to the communication path management module to determine the latency measurement as the time elapsed from the bit pattern receipt at the first input port of the selected end-to-end communication path and the bit pattern receipt at the last output port in the selected end-to-end communication path.

17. The physical cross-connect switch of claim 11, wherein a PLCC switch traversed by a selected end-to-end communication path is commanded to turn a selected port on and off in a predetermined power cycle pattern, and wherein the non-transitory computer-readable medium stores executable instructions that, when executed by the processor, are operative to:
receive a request to detect a signal power level changing in the predetermined power cycle pattern at any input port;
poll each input port to detect the signal power level changing in the predetermined power cycle pattern;
identify the input port at which the predetermined power cycle pattern was detected; and
report the input port at which the predetermined power cycle pattern was detected to the communication path management module.

18. The physical cross-connect switch of claim 11, wherein the PLCC switch is traversed by end-to-end communication paths that traverse at least one other PLCC switch, and wherein the non-transitory computer-readable medium stores executable instructions that, when executed by the processor, are operative to:
receive a path discovery request to discover a communication path traversing a selected one of the plurality of input ports;
determine a test packet to transmit at the selected one of the plurality of input ports;
broadcast a request to the at least one other PLCC switch to record data at each port on the at least one other PLCC switch and to search for the test packet in the recorded data;
connect the monitor port to the selected one of the plurality of input ports; and
transmit the test packet at the selected one of the plurality of input ports via the monitor port, wherein each of the at least one other PLCC switch reports each port at which the test packet was detected to the communication path management module for identification of a path traversing the selected one of the plurality of input ports.

19. The physical cross-connect switch of claim 11, wherein the PLCC switch is traversed by end-to-end communication paths that traverse at least one other PLCC switch, and wherein the non-transitory computer-readable medium stores executable instructions that, when executed by the processor, are operative to:
receive a request to discover paths traversing the PLCC switch, wherein the request is broadcast to the at least one other PLCC switch;
connect each of the plurality of input ports to the at least one monitor port for a scan time;
record data received at each of the plurality of input ports; and
communicate the recorded data to the communications path management module for matching of recorded data to determine paths through the PLCC switch.

20. The physical cross-connect switch of claim 11, wherein the non-transitory computer-readable medium stores executable instructions that, when executed by the processor, are operative to:
identify at least one block of data in the replicated signals;
perform at least one layer 2 metric selected from:
a cyclic redundancy check (CRC) on the at least one block of data,
a parity check on the at least one block of data,
a packet error rate (PER) determination,
a bit error rage (BER) determination, and
a time stamp; and
communicate a result the selected layer 2 metric and block of data as the signal characteristic.
